(19) United States
(12) Patent Application Publication
(10) Pub. No.: US 2008/0078980 A1
(43) Pub. Date: Apr. 3, 2008

(54) HIGH-TORQUE MULTI-SPEED WINCH

(76) Inventors: Richard E. Aho, Fort Lauderdale, FL (US); Drew V. Aho, Coral Springs, FL (US); Srikanth Kanchibhotla, Pompano Beach, FL (US)

Correspondence Address: LUEDEKA, NEELY & GRAHAM, P.C., P O BOX 1871, KNOXVILLE, TN, 37901, US

(21) Appl. No.: 11/466,959

(22) Filed: Aug. 24, 2006

(51) Int. Cl. B66D 1/22

(52) U.S. Cl. 254/344

(57) ABSTRACT

An adjustable speed winch includes a winch housing, a winch drum rotatably connected to the winch housing, a winch motor, a drive shaft, motor shaft coupling means, direct drive means, first gear reduction means and selection means. The motor includes a motor shaft rotating at a first speed. The motor shaft is coupled to the drive shaft by way of the motor shaft coupling means so that the drive shaft rotates at a second speed. In some embodiments, the second speed is the same as the first speed, while in some embodiments the second speed is less than the first speed. The direct drive means couple the winch drum to the drive shaft so that the winch drum also rotates at the second speed when the direct drive means is engaged. The first gear reduction means couple the winch drum to the drive shaft so that the drum rotates at a third speed that is less than the second speed when the first gear reduction means is engaged. The selection means provide for switching between the direct drive means and the first gear reduction means, the choice of which determines the rotation speed of the winch drum.

### TECHNICAL FIELD

The present invention is directed to a high-torque multi-speed hydraulic vehicle winch which utilizes the vehicle's power steering system as a source of hydraulic power.

### BACKGROUND

The advantages of having a winch mounted to a vehicle have long been appreciated. For off-road adventures, a winch provides a highly effective means for extraction of the vehicle when stuck in mud or when the vehicle has become high-centered in rough terrain. The winch extends the range of the vehicle by encouraging the off-road adventurer to push the vehicle's performance envelope where he would otherwise be afraid to do, and when that envelope has been exceeded, to bring the vehicle back to within its operational limitations. The winch can be used for endless other applications as well, including rescuing other vehicles from perilous mud holes, moving large objects such as felled trees and towing other vehicles.

While it is necessary to have low-speed, high-torque winch operation to move heavy loads, it is often desirable to operate the winch at a higher speed to quickly take up slack in a cable before moving a load or to quickly retrieve a long length of cable after a load has been moved. Thus, a convenient and reliable means of switching between high-speed, low-torque operation and low-speed, high-torque operation in a vehicle-mounted winch is desirable.

### SUMMARY

The above and other needs are met by an adjustable speed winch that includes a winch housing, a winch drum rotatably connected to the winch housing, a winch motor, a drive shaft, motor shaft coupling means, direct drive means, first gear reduction means and selection means. The motor includes a motor shaft rotating at a first speed. The motor shaft is coupled to the drive shaft by way of the motor shaft coupling means so that the drive shaft rotates at a second speed. In some embodiments, the second speed is the same as the first speed, while in some embodiments the second speed is less than the first speed. The direct drive means couple the winch drum to the drive shaft so that the winch drum also rotates at the second speed when the direct drive means is engaged. The first gear reduction means couple the winch drum to the drive shaft so that the drum rotates at a third speed that is less than the second speed when the first gear reduction means is engaged. The selection means provide for switching between the direct drive means and the first gear reduction means, the choice of which determines the rotation speed of the winch drum.

In some preferred embodiments, the motor shaft coupling means include second gear reduction means that cause the drive shaft to rotate at about one sixth (⅙) the speed of the motor shaft. In some embodiments, the first gear reduction means cause the winch drum to rotate at about one third (⅓) the speed of the drive shaft.

In some embodiments of the invention, the first gear reduction means include a first pinion gear coupled to the first end of the drive shaft and a drum drive plate attached to the winch drum. A plurality of first planet gear shafts extend outward from the drum drive plate, and a corresponding number of first planet gears are rotatably coupled to the first planet gear shafts. These embodiments also include a first ring gear that is rotatably coupled to the winch housing. The first planet gears are meshed with the first pinion gear and the first ring gear.

In some embodiments, the second gear reduction means include a second pinion gear coupled to the motor shaft and a drive shaft plate coupled to the second end of the drive shaft. A plurality of second planet gear shafts extend outward from the drive shaft plate, and a corresponding number of second planet gears are rotatably coupled to the second planet gear shafts. These embodiments also include a second ring gear attached to the winch housing. The second planet gears are meshed with the second pinion gear and the second ring gear.

The direct drive means preferably comprise a coupling plate having a central opening that is keyed for engaging and being rotatably driven by the first pinion gear. The coupling plate includes a plurality of peripheral openings that are disposed radially about the central opening. Each of the peripheral openings are positioned to slidingly receive a corresponding one of the first plant gear shafts.

The selection means preferably include means for moving the coupling plate between first and second axial positions relative to the first pinion gear. When the coupling plate is in the first axial position, the central opening of the coupling plate engages the first pinion gear so that the direct drive means is engaged. When the coupling plate is in the second axial position, the central opening of the coupling plate disengages from the first pinion gear so that the direct drive means is disengaged.

Preferred embodiments of the winch are primarily for use on vehicles with power steering fluid specifications of 2500-3000 pounds per square inch (PSI) and 8-12 gallons per minute (GPM). However, the winch is fully functional even on vehicles having lower-end fluid specifications of 1500 PSI and 4 GPM. Some embodiments of the winch are also functional in industrial applications wherein flow rates are over 12 GPM, although for safety reasons, two-speed operation of the winch can be disabled for applications having such high flow rates.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a cross-sectional view of a high-torque multi-speed winch according to a preferred embodiment of the invention;

FIG. 2 depicts a cross-sectional view of a 3-to-1 gear reduction assembly according to a preferred embodiment of the invention;

FIG. 3 depicts a cross-sectional view of a 6-to-1 gear reduction assembly according to a preferred embodiment of the invention; and

FIG. 4 depicts an exploded view of a high-torque multi-speed winch according to a preferred embodiment of the invention.

### DETAILED DESCRIPTION

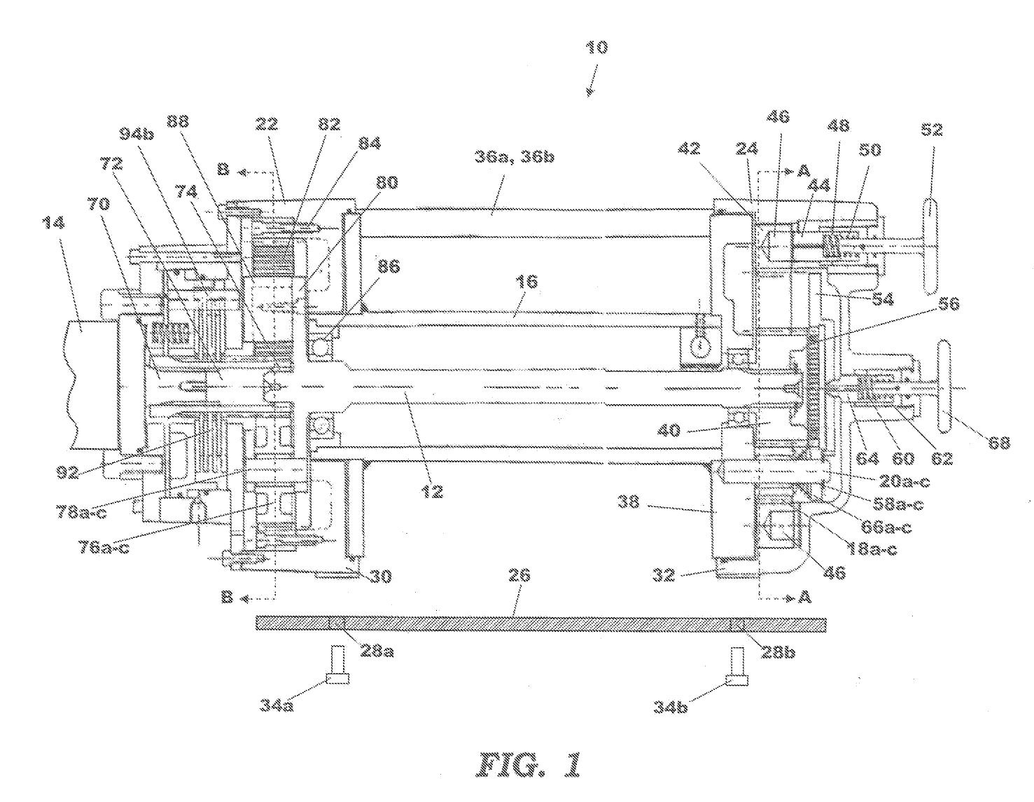

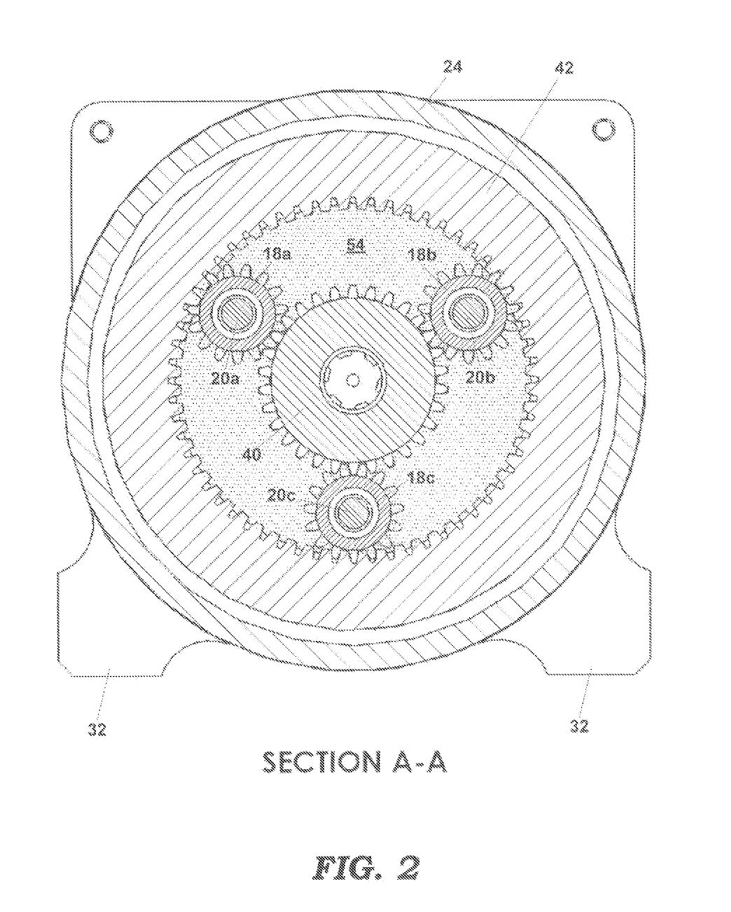

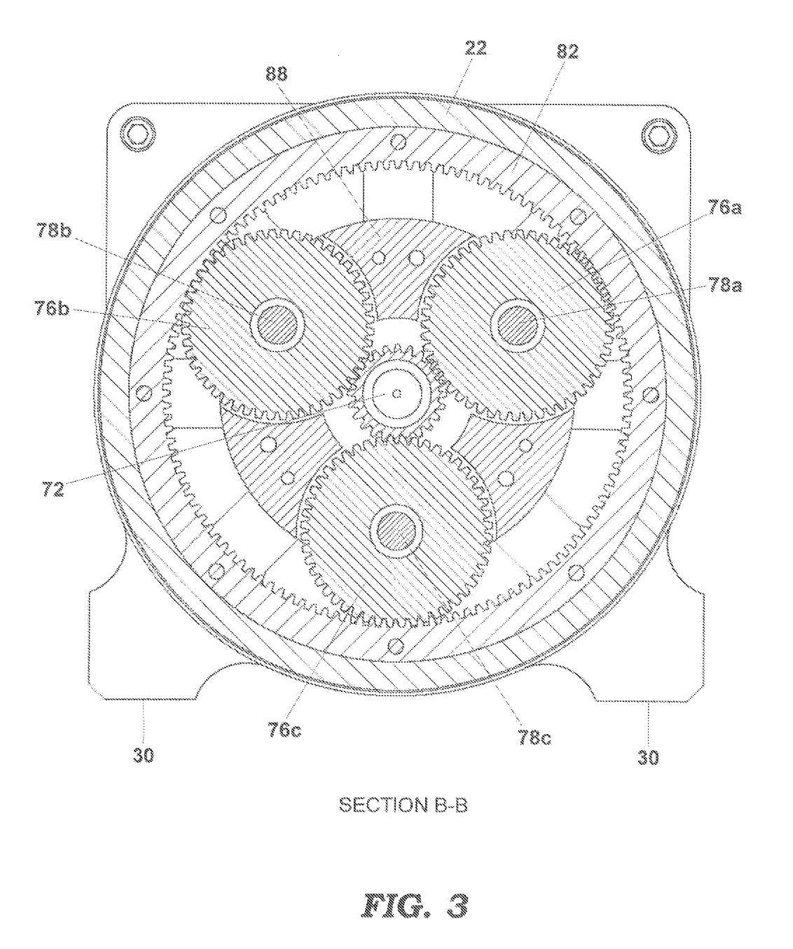

FIGS. 1-4 depict a preferred embodiment of a hydraulic high-torque multi-speed vehicle winch 10. The winch 10 includes a drive shaft 12 which is driven by a hydraulic winch motor 14. The drive shaft 12 extends through the axial center of a winch drum 16 which is held in place by a motor end housing 22 and a drive end housing 24. A mounting plate 26 provides a substrate on which the housings 22 and 24 rest when attached to a host vehicle. Bolt holes in the mounting plate 26 (shown generally at 28a and 28b) align with threaded holes in a motor end support 30 and the drive end support 32. As shown in FIG. 1, the housings 22 and 24 are mounted to the base plate 26 and host vehicle by means of bolts shown generally as 34a and 34b.

The housings 22 and 24 are connected together by two tie rods 36a and 36b. Although two tie rods 36a and 36b are provided in the preferred embodiment, it will be understood that a single tie rod can be used instead. Further, it will be appreciated that when the tie rods 36a and 36b are removed, the housings 22 and 24 and the winch drum 16 are no longer connected and can be pulled apart freely, thereby simplifying maintenance. In other words, the winch drum 16 is effectively held in place and supported by the housings 22 and 24 when the latter are connected by means of the tie rods 36a and 36b.

The winch drum 16 is coupled to the drive shaft 12 via reduction gearing contained within the drive end housing 24 so that the drum 16 rotates in response to operation of the winch motor 14. In this manner, cable is released from the drum 16 as the winch motor 14 turns in a forward direction and is retrieved as the winch motor 14 turns in a reverse direction. Typical reduction gearing apparatuses and methods can be used to suitably couple the drive shaft 12 and winch drum 16, and to provide sufficient torque output to the winch drum 16.

In a preferred embodiment, the winch motor 14 is a low-speed, high-torque motor with 160 cc capacity. Suitable sources for such motors include White Hydraulics of Louisville, Ky. and the Dan Foss Company which is located in Wisconsin. The motor 14 may be driven by the host vehicle's hydraulic pressure supply. For example, the vehicle's power steering system may be utilized to provide hydraulic pressure for operation of the winch motor 14 as described in U.S. Pat. No. 5,842,684, the full disclosure of which is incorporated herein by reference. For a typical vehicle installation where the motor 14 is powered by a vehicle's power steering system, the vehicle's power steering pump will supply hydraulic fluid to the motor 14 at a pressure of about 2500 PSI with a flow rate of about eight GPM. This installation configuration produces a maximum torque of about 36,000 lb-in on the winch drum bottom wind and a nominal drum rotation rate of about 12 RPM during winch motor operation. However, it will be understood that the maximum torque and nominal drum rotation rate will vary depending on the particular installation configuration as well as the particular gear reduction ratio employed.

A preferred reduction gearing apparatus for coupling the drive shaft 12 to the winch drum 16 is illustrated in FIGS. 1, 2 and 4. The drive shaft 12 extends through the axial center of the winch drum 16 and engages an arrangement of three planet gears 18a-c which rotate upon three planet gear shafts 20a-c. As shown in FIG. 1, one end of each planet gear shaft 20a-c is attached to a drum drive plate 38 which is rigidly attached to the winch drum 16, such as by a weld. The planet gear shafts 20a-c are radially spaced at 120 degrees about the perimeter of the drum drive plate 38. A pinion gear 40 at the end of the drive shaft 12 engages the planet gears 18a-c so that the planet gears 18a-c rotate in response to rotation of the drive shaft 12. A ring gear 42 meshes with the planet gears 18a-c so that when the ring gear 42 is locked to the drive end housing 24 by means of a gear reduction plunger 44, rotation of the drive shaft 12 causes the winch drum 16 to rotate at a speed slower than that of the drive shaft 12. In a preferred embodiment, the gear reduction ratio achieved with this arrangement is three-to-one (3:1). However, it will be understood that other gear reduction ratios can be achieved with the gear reduction arrangement shown.

The gear reduction plunger 44 mechanically couples the ring gear 42 to the drive end housing 24 by means of holes 46 along the outer surface of the ring gear 42. When the plunger 44 is retracted, and thereby removed from the holes 46, the ring gear 42 and planet gears 18a-c are drivingly decoupled from the winch drum 16. In other words, retracting the plunger 44 from the ring gear 42 effectively decouples the drive shaft 12 from the winch drum 16 so that the winch drum 16 free-spools. In this manner, a free-spooling capability is provided whereby cable may be unwound from the winch drum 16 without the assistance of the winch motor 14. This free-spooling capability is particularly useful for rapid removal of cable from the winch drum 16.

In a preferred embodiment, the gear reduction plunger 44 is urged toward the ring gear 42 by a spring 48. To disengage the plunger 44 from the ring gear 42, the plunger 44 is pulled in a axial direction away from the ring gear 42 by the rotation of a cam sleeve 50 to which the plunger 44 is attached. This condition is illustrated in FIG. 1. The cam sleeve 50 is rotated by means of a gear reduction selector handle 52 so that the winch drum 16 is made to free-spool when the gear reduction selector handle 52 is in the position shown in FIG. 1. When the gear reduction selector handle 52 is rotated 180 degrees clockwise from the position shown in FIG. 1, the ring gear 42 is locked to the housing 24, thus disabling free-spool operation.

The winch drum may be driven in a high-speed, low-torque mode by coupling the rotation of the drive shaft 12 directly to the winch drum 16 with no gear reduction. A higher drum rotation speed is useful in retrieving long lengths of unspooled cable after load-moving operations are complete, or in taking up slack in the cable prior to moving a load. In the preferred embodiment of the invention, the coupling of the drive shaft 12 to the winch drum 16 is attained by a coupling plate 54 which is moveable between two axial positions: a low-speed position in which the winch drum 16 is decoupled from the drive shaft 12, and a high-speed position in which the winch drum is coupled to the drive shaft 12. For the exemplary vehicle installation described above (2500 PSI at eight GPM), the direct drive arrangement produces a nominal drum rotation rate of 38 rpm and a maximum torque of 2000 lb-in during winch motor operation.

As shown in FIGS. 1, 2 and 4, the coupling plate 54 of the preferred embodiment is a circular plate with a keyed opening 56 at its center. The shape of the keyed opening 56 matches the pinion gear 40 at the end of the drive shaft 12. The coupling plate 54 also has three openings 58a-c that are radially spaced at 120 degrees about its perimeter. The position and spacing of these openings 58a-c match the position and spacing of the planet gear shafts 20a-c which extend from the drive drum plate 38. With this arrangement, the coupling plate 54 is coupled to the winch drum 16 by engaging the planet gear shafts 20a-c in the openings 58a-c. The openings 58a-c are of sufficient diameter for the coupling plate 54 to slide freely in an axial direction on the planet gear shafts 20a-c.

With reference to FIG. 1, as the coupling plate 54 slides toward the drive shaft 12, the keyed hole 56 in the coupling plate 54 engages the pinion gear 40, thereby causing the coupling plate 54 to rotate at the same speed as the drive shaft 12. In this manner, the drive shaft 12 is directly coupled to the winch drum 16 through the coupling plate 54 and the planet gear shafts 20a-c.

It will be appreciated that high-speed operation of the winch 10 is achieved only when the gear reduction plunger 44 is retracted. In such a position, the plunger 44 does not engage any of the holes 46 in the ring gear 42, and the ring gear is free to rotate along with winch drum 16. If the plunger 44 is engaged in a hole 46 in the ring gear 42, no rotation of the ring gear 42 or the drive shaft 12 may occur. This is due to the meshing of the planet gears 18a-c with the ring gear 42 and the coupling of the drive shaft 12 to the planet gear shafts 20a-c by means of the coupling plate 54. In other words, when the plunger 44 is engaged with any of the holes 46 and the coupling plate 54 is engaged with the drive shaft 12, the winch drum 16 is in a locked position.

It will be appreciated that many mechanisms could be employed to move the coupling plate 54 in an axial direction to engage or disengage the drive shaft 12. FIG. 1 depicts the mechanism of a preferred embodiment. The coupling plate 54 is urged toward the pinion gear 40 by a plunger spring 60 which is in compression between a plunger 64 and a cam sleeve 62. When the keyed hole 56 in the coupling plate 54 aligns with the pinion gear 40, the spring 60 pushes the coupling plate 54 into engagement with the pinion gear 40. A set of three coupling plate springs 66a-c, which are in compression between the coupling plate 54 and the planet gears 18a-c, push the coupling plate 54 against the plunger 64. In this manner, the coupling plate 54 maintains continuous contact with the plunger 64. The moduli of the coupling plate springs 66a-c are preferably less than that of the plunger spring 60 so that the coupling plate 54 will be forced into engagement with the pinion gear 40 when no other axial force is applied.

The plunger spring 60 allows for misalignment between the pinion gear 40 and the keyed hole 56 by holding the coupling plate 54 against the pinion gear 40 until proper alignment is achieved through rotation of the pinion gear 40 or otherwise. If misalignment between the keyed hole 56 and pinion gear 40 occurs, the plunger spring 60 will hold the coupling plate 54 against the pinion gear 40 until there is proper alignment. In this manner, the plunger spring 60 helps compensate and correct for initial misalignment.

To disengage the coupling plate 54 from the pinion gear 40, the plunger 64 is pulled away from the coupling plate 54 by the rotation of a cam sleeve 136 to which the plunger 64 is attached. This compresses the plunger spring 60, and the keyed hole 56 and pinion gear 40 disengage. This condition is illustrated in FIG. 1. In the preferred embodiment, the cam sleeve 62 is rotated by means of a direct drive handle 68.

A preferred embodiment of reduction gearing apparatus for coupling the motor 14 to the drive shaft 12 is depicted in FIGS. 1, 3 and 4. In this embodiment, the motor 14 drives a motor shaft 70 which is connected to a motor shaft pinion gear 72. Although the pinion gear 72 is coaxial with the drive shaft 12, the pinion gear 72 is not rotationally coupled to the shaft 12. Rather, the pinion gear 72 rides on a pinion gear bearing 74 disposed between the gear 72 and the shaft 12.

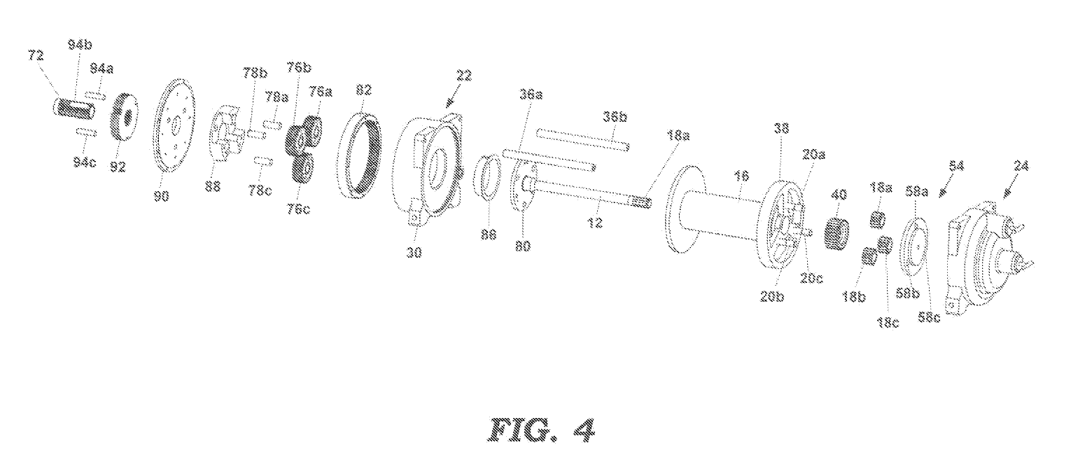

The pinion gear 72 meshes with three planet gears 76a-c that are preferably spaced at 120 degree increments about the axis of the pinion gear 72. The planet gears 76a-c are free to rotate about corresponding planet gear pins 78a-c, the ends of which are secured to a drive shaft plate 80 and a planet gear support 88. In the preferred embodiment of the invention, the drive shaft plate 80 is formed as an integral part of the drive shaft 12. However, it will be appreciated that the plate 80 may be attached to the shaft 12 by various means, such as by welding. The planet gears 76a-c mesh with a ring gear 82 which is secured to the motor end housing 22 by screws 84. A drum bearing 86 provides freedom of rotation between the drive shaft 12 and the drum 16. As shown in FIGS. 1 and 4, a braking mechanism for the winch 10 includes brake plates 92 and brake stop pins 94a, 94b and 94c.

In the preferred embodiment of the invention, the gear reduction ratio from the motor shaft 70 to the drive shaft 12 is six-to-one (6-to-1). This provides a torque which is twice that of the winch design described in U.S. Pat. No. 5,842,684.

In alternative embodiments of the invention, the motor shaft 70 may be coupled directly to the drive shaft 12, such as using a shaft coupler. In this embodiment, the drive shaft 12 rotates at the same speed as the motor shaft 70.

According to the preferred embodiment of the invention, the winch operator may select from four different modes of winch operation depending upon the positions of the gear reduction selector handle 52 and the direct drive selector handle 68. Low-speed winch operation is selected when the direct drive selector handle 68 is in the position shown in FIG. 1 and the gear reduction selector handle 52 is rotated 180 degrees clockwise from the position shown in FIG. 1. High-speed winch operation is selected when the direct drive selector handle 68 is rotated 180 degrees clockwise from the position shown in FIG. 1 and the gear reduction selector handle 52 is in the position shown in FIG. 1. Free-spool winch operation is selected when the direct drive selector handle 68 and the gear reduction selector handle 52 are both in the positions shown in FIG. 1. The winch is locked/braked (no dram rotation) when the direct drive selector handle 68 and the gear reduction selector handle 52 are both rotated 180 degrees clockwise from the positions shown in FIG. 1.

In the preferred embodiment of the invention, the gear reduction plunger 44 and the direct drive plunger 64 are moved manually using the handles 52 and 68, respectively. However, one skilled in the art will appreciate that the plungers 44 and 64 may also be actuated by solenoids powered by the battery of the vehicle on which the winch 10 is mounted. An example of a circuit for controlling solenoids in this application is described in U.S. Pat. No. 5,842,684.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An adjustable speed winch comprising:
a winch housing;
a winch drum rotatably connected to the winch housing;
a winch motor attached to the winch housing, the winch motor having a motor shaft rotating at a first speed;
a drive shaft having opposed first and second ends;
motor shaft coupling means for rotatably coupling the motor shaft to the second end of the drive shaft to cause the drive shaft to rotates at a second speed which is different from the first speed;
direct drive means for rotatably coupling the winch drum to the first end of the drive shaft to cause the winch drum to rotates at the second speed;
first gear reduction means for rotatably coupling the winch drum to the first end of the drive shaft to cause the winch drum to rotates at a third speed that is less than the second speed; and
selection means for switching between the direct drive means and the first gear reduction means.

2. The adjustable speed winch of claim 1 wherein the first gear reduction means comprise:
a first pinion gear coupled to the first end of the drive shaft;
a drum drive plate attached to the winch drum;
a plurality of first planet gear shafts attached to and extending outward from the drum drive plate;
a first ring gear rotatably coupled to the winch housing; and
a plurality of first planet gears meshed with the first pinion gear and the first ring gear, each of the first planet gears rotatably coupled to a corresponding one of the first planet gear shafts.

3. (canceled)

4. The adjustable speed winch of claim 1 wherein the motor shaft coupling means further comprise second gear reduction means for rotatably coupling the motor shaft to the second end of the drive shaft to cause the drive shaft to rotates at the second speed which is less than the first speed.

5. The adjustable speed winch of claim 4 wherein
the second gear reduction means couple the motor shaft to the second end of the drive shaft to cause the drive shaft to rotate at the second speed which is about one sixth (⅙) the first speed; and
the first gear reduction means couple the winch drum to the first end of the drive shaft to cause the winch drum to rotates at a third speed which is about one third (⅓) the second speed.

6. The adjustable speed winch of claim 4 wherein the second gear reduction means comprise:
a second pinion gear coupled to the motor shaft;
a drive shaft plate coupled to the first end of the drive shaft;
a plurality of second planet gear shafts connected to and extending outward from the drive shaft plate;
a second ring gear connected to the winch housing; and
a plurality of second planet gears meshed with the second pinion gear and the second ring gear, each of the second planet gears rotatably connected to a corresponding one of the second planet gear shafts.

7. The adjustable speed winch of claim 2 wherein the direct drive means comprise a coupling plate including:
a central opening keyed for engaging and being rotatably driven by the first pinion gear;
a plurality of peripheral openings disposed radially about the central opening, each peripheral opening positioned to slidingly receive a corresponding one of the first planet gear shafts.

8. The adjustable speed winch of claim 7 wherein the selection means include means for moving the coupling plate between first and second axial positions relative to the first pinion gear, whereby the central opening of the coupling plate engages the first pinion gear when the coupling plate is in the first axial position, and whereby the central opening of the coupling plate disengages from the first pinion gear when the coupling plate is in the second axial position.

9. The adjustable speed winch of claim 8 wherein the means for moving the coupling plate comprise:
a first plunger having opposed first and second ends, where the first end of the first plunger engages the coupling plate;
a first cam sleeve having a central axial cavity, the first cam sleeve for engaging the second end of the first plunger;
a first spring disposed within the cavity of the first cam sleeve and in compression between the second end of the first plunger and the first cam sleeve, the first spring for urging the first plunger toward the coupling plate;
a direct drive handle for engaging the first cam sleeve to move the first plunger between first and second plunger positions, where in the first plunger position the first plunger urges the coupling plate into the first axial position and in the second plunger position the first plunger releases the coupling plate to move to the second axial position; and
a plurality of coupling plate springs in compression between the first planet gears and the coupling plate, the coupling plate springs urging the coupling plate toward the second axial position.

10. The adjustable speed winch of claim 2 wherein the selection means include means for locking the first ring gear so that the first ring gear does not rotate in relation to the winch housing and for unlocking the first ring gear so that the first ring gear is free to rotate in relation to the winch housing.

11. The adjustable speed winch of claim 10 wherein the means for locking and unlocking the first ring gear comprise:
a plurality of holes disposed radially about the periphery of the first ring gear;
a second plunger having opposed first and second ends, where the first end of the second plunger is operable to be received in one of the plurality of holes in the first ring gear;
a second cam sleeve having a central axial cavity, the second cam sleeve for engaging the second end of the second plunger;
a second spring disposed within the cavity of the second cam sleeve and in compression between the second end of the second plunger and the second cam sleeve, the second spring for urging the second plunger toward the first ring gear;
a gear reduction selector handle for engaging the second cam sleeve to move the second plunger between first and second plunger positions, where in the first plunger position the first end of the second plunger is urged by the second spring into one of the plurality of holes in the first ring gear so that the first ring gear does not rotate in relation to the winch housing, and in the second plunger position the first end of the second plunger pulled away from the first ring gear to be disengaged from the holes in the first ring gear so that the first ring gear is free to rotate in relation to the winch housing.

12. An adjustable speed winch comprising:
a winch housing;
a winch drum rotatably connected to the winch housing;
a winch motor attached to the winch housing, the winch motor having a motor shaft;
a drive shaft having opposed first and second ends;
a second pinion gear coaxially attached to the motor shaft;
a drive shaft plate coaxially attached to the second end of the drive shaft;
a plurality of second planet gear shafts connected to and extending outward from the drive shaft plate:
a second ring gear connected to the winch housing;
a p1ura1ity of second planet gears meshed with the second pinion gear and the second ring gear, each of the second planet gears rotatably connected to a corresponding one of the second planet gear shafts;
a first pinion gear at the first end of the drive shaft;
a drum drive plate attached to the winch drum;
a plurality of first planet gear shafts attached to and extending outward from the drum drive plate;
a first ring gear rotatably coupled to the winch housing;
a plurality of first planet gears meshed with the pinion gear and the first ring gear, each of the first planet gears rotatably coupled to a corresponding one of the first planet gear shafts;
a coupling plate including:
a central opening keyed for engaging and being rotatably driven by the first pinion gear;
a plurality of peripheral openings disposed radially about the central opening, each of the peripheral openings positioned to slidingly receive a corresponding one of the first planet gear shafts;
means for moving the coupling plate between first and second axial positions relative to the first pinion gear, whereby the central opening of the coupling plate engages the first pinion gear when the coupling plate is in the first axial position, and whereby the central opening of the coupling plate disengages the first pinion gear when the coupling plate is in the second axial position; and
means for locking the first ring gear so that the first ring gear does not rotate in relation to the winch housing and for unlocking the first ring gear so that the first ring gear is free to rotate in relation to the winch housing.

13. An adjustable speed winch comprising:
a winch housing;
a winch drum rotatably connected to the winch housing;
a winch motor attached to the winch housing, the winch motor having a motor shaft rotating at a first speed;
second planet gears rotatably coupled to the motor shaft;
a drive shaft having a first end and an opposing second end, the second end rotatably coupled to the second planet gears to cause the drive shaft to rotate at a second speed which is different from the first speed;
first planet gears rotatably coupled to the winch drum and the first end of the drive shaft to cause the winch drum to rotate at a third speed which is less than the second speed; and
a coupling plate that is operable to selectively move between first and second axial positions, the coupling plate engaging the first end of the drive shaft when the coupling plate is in the first axial position to cause the winch drum to rotate at the second speed, the coupling plate disengaging the first end of the drive shaft when the coupling plate is in the second axial position to allow the winch drum to rotate at the third speed.
